(19) United States
(12) Patent Application Publication
(10) Pub. No.: US 2004/0038034 A1
(43) Pub. Date: Feb. 26, 2004

(54) Method for the manufacture of self adhesive lables

(76) Inventor: Luis Martin Dominguez, Buenos Aires (AR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/370,069

(22) Filed: Feb. 21, 2003

(30) Foreign Application Priority Data
Feb. 21, 2002 (AR) P 2002 01 00601

(51) Int. Cl. B32B 9/04

(52) U.S. Cl. 428/411.1

(57) ABSTRACT

A method for manufacture of self adhesive labels, of the type in which the labels are formed by an adhesive frontal involving a self adhesive compound having a silicone base, “liner”, as a support, “carrier”, of the set, characterized in that it includes a first initial stage of printing of the label graphic design on a simple laminar material fully independent from the material of the self adhesive compound, forming a coil from which it follows a complementary stage of inspection, developing the printed laminar material, so as to be able to thoroughly purify it and in all senses, according to the established parameters, discarding the wrong printed parts and making an assembly with the valid sections, in order to complete this stage with a final rewinding of this well printed simple laminar material, ready to be incorporated to the self adhesive compound, and which coil is conducted to a warehouse for its direct use when the labels are required and, lastly, a second stage of direct incorporation of such printed simple material on the self adhesive compound, proceeding to lamination so as to glue this printed laminar material on the compound, proceeding to lamination so as to glue this printed laminar material on the compound frontal, under conditions which subsequently allow, its die-cutting to half cut and detachment from the grid comprised by the surplus of such simple laminar material carrier of the printing around the labels.

This inventions relates to a method for the manufacture of “selfadhesive labels” of the kind in which labels are made by a frontal adhesive part forming a selfadhesive compound having a silicone base—liner as support—“carrier” of the set.

With the object of a better understanding of the aim method of this invention and its scope, we make reference to the following statements:

The so-called selfadhesive labels are printed on what is called “selfadhesive compound”, which has a support or silicone base, “liner”, on which an adhesive printable frontal material is applied, this keeps the support fixed, but in conditions that once conveniently printed, laminated and cut by die, allow its detachment taking the printing and the adhesive frontal, that is to say, the label itself, that shall make possible its fixing in the place whereinto it is applied, for example, the face of a container.

Normally, labels are printed directly on the above-mentioned printable frontal material of said “selfadhesive compound”, they are laminated or varnished, the label itself is cut in a die with “half cut” and the remaining material is detached from said frontal commonly called “grid” as it is made up in the shape of a pierced strip by the openings that labels leave.

This means that selfadhesive labels are detached from the printing machine under the shape of a coil that has the silicone support with the labels affixed on one face of same, in the frontal where they were printed, in addition to the external laminated coating on same, that is to say a set of a proportionally very high cost with regards to the cost of the printable material that together with the ink comprises the body of the label, which “per se” may be considered, according to the employed material between ¼ to 1/20 of the total cost of the printed “selfadhesive compound”, that is to say finished and coiled in conditions to be delivered to the user.

As contrasted with this, the main and basic purpose of this patent is obtaining a manufacturing method that makes possible the independence of the label printing in relation to the selfadhesive compound, so as to make possible to operate initially, using low costs materials and not only this, but also in such conditions that allow obtaining, moreover, a printing with a higher quality presentation in relation to the finish that is feasible to obtain with the above-mentioned conventional process of direct printing on the selfadhesive set.

It is also interesting to obtain, as complement of what was previously stated, the possibility of exercising a meticulous control and regulation of the printing in every sense: color adjustment, register, etc., discarding without cost problems everything that do not satisfy completely the established parameters, to the point of being able to discard, if necessary, a complete coil or a large part of same, without implying a sensible increase in the finished product cost, being the eventual discard restricted to the material in which the printing has been made and the ink used for that purpose, without involving, therefore, any part of the selfadhesive compound, that, when proceeding this way, remains completely out of line.

Likewise and in direct relation to what was previously stated, the purpose is to achieve that the label “per se” obtained at a level of maximum simplicity, may also be employed to satisfy different final requirements of high level: for example, metallized or “stamping” imitation, by the simple fact of incorporating the so obtained printing laminating it to a selfadhesive compound with a metallized frontal, making possible in this way, that a same base product, incorporating the essential material to the label, that is to say the printing, in a simple laminar carrier of a very low cost, may be used to make labels of different kind in relation to quality and finish.

### SUMMARY

All these purposes as well as others that shall be disclosed farther on, have been made concrete in a practical way in the invented method, which developed on the basis of the general features raised from what was previously stated, have their characterization centered on the fact that it consists of a first printing stage of the label on a simple laminar material in a completely independent way from the selfadhesive compound and continues in a second complementary stage that goes on to review and inspection, discarding the wrong printed parts, purifying the set leaving it ready for its lamination to the selfadhesive compound, continuing to a last closure coiling of this stage, for the following storage in a coil file of the simple laminar material with the printings made on same, waiting the assembly of the final compound and, finally, a third stage of incorporation of said simple laminar printed material applying it on the corresponding frontal material of the selfadhesive compound, continuing to a simple process of lamination, so as to glue this printed material on the corresponding frontal face of same in conditions that allow its later die-cutting process at half cut and detachment from the grid resulting from this operation made up of surplus of said simple laminar material, so as to finish in a final rewinding.

### BRIEF DESCRIPTION OF THE DRAWINGS

So as to ease the understanding of this invention and for a better clearness of same, the illustrative schemes of how is possible to carry out the invented method according to one of the preferred embodiments of the invention is attached, as an example:

FIG. 1 is a scheme of the printing process and film winding in which the labels are printed.

FIG. 2 is a scheme of the control, review and selection process of the printing material with discarding of the faulty parts, with the later rewinding and film file cleansing in conditions to be laminated to the selfadhesive material.

FIG. 3 is a scheme of how the printed coil, detached from the file goes through the stage of lamination on the “selfadhesive compound” with the application of the corresponding adhesive film.

FIG. 3′ is a complementary scheme of what was illustrated in FIG. 3, showing 1) cut in a die at half cut and 2) grid detachment and final rewinding for its dispatch.

In all the different Figures the same symbols refer to the same elements or similar parts.

### DESCRIPTION

According to what was stated and illustrated, the manufacturing method of selfadhesive labels is developed, according to general features on the basis of the previous printing of the label itself in a completely independent way from the usual selfadhesive compound, proceeding as follows:

In a printing train a a simple laminar material b is printed coming from a coil 1, of minimum cost compared to a selfadhesive compound, or more exactly to the proper conventional compound of frontal selfadhesive in addition to the silicone support—FIG. 1

Thus, every waste of the machine setting, color adjustment, register, etc., shall be produced on a simple laminar material b of a so reduced cost that allows to work trying to obtain a very good printing i without problems for the discarding a posteriori when purifying the obtained material under the shape of a coil 2 of the above mentioned film—FIG. 1.

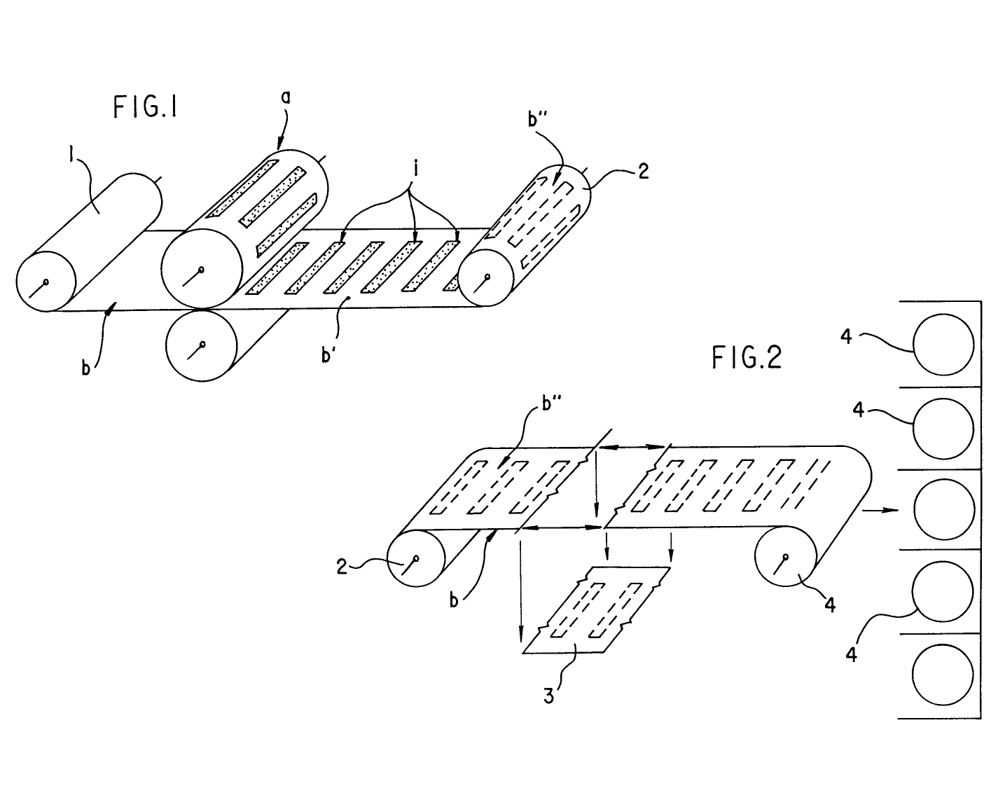

Once a good or an optimum printing i level of the E labels is achieved, it is proceeded, FIG. 2, to remove all parts 3 that do not satisfy completely making the assembly with the parts ready for the final product, obtaining thus a coil 4 of the fully purified piece, in an operation called as finish of the printing stage in the strict sense.

It is possible to operate in this way, since the employed simple laminar material b has, as basic factor of characterization of the aim method of the present invention, a very low, that is to say a minimum incidence in the final cost of the product: label E, since the simple material used, a non-restrictive example, by polypropylene or polyester or simple paper, these materials have a cost between ¼ and 1/20 of the total cost of the selfadhesive compound: frontal with adhesive feature and support.

A particular characterization of this method is the fact that when operating in a separate way from the selfadhesive compound with its habitual selfadhesive frontal, the label may be printed in a mirror, in the reverse or internal part b′ of a film b of transparent material, therefore, the ink, their features, distribution, etc., and in consequence the visible part of the label when is applied later on may be appreciated directly on the obverse b″ of the film, FIG. 2, from which it is feasible to see the face of the ink film exposed when applying the label.

It is important to point out that a fundamental matter is that when printing on the internal or reverse face of the film, the ink and therefore the label itself is protected from same, and therefore when the adhesive is below the ink, it does not undergo any imperfection, nor bubbles proper of the overlamination which is performed when putting the adhesive element according to the conventional system of direct printing on the frontal of the selfadhesive compound, in which this lamination process is carried out putting the adhesive element directly on the ink.

Once the basic printing stage is complete with the referred rewinding so as to expose the printed film and thus to proceed to the cleaning of the material of every imperfection, it is possible to file, so as to say, the coils 4 of the printed simple laminar material of very low cost, fully purified and, therefore, ready to be used when it is necessary to assemble, at the user request, one or more coils with this printed material and therefore it is proceeded to incorporate same to the selfadhesive compound, laminated and cut in a die to this material with half cut to register, over the frontal of this selfadhesive compound, taking from said file the batches (coils) of printed simple material required to be delivered in a lot.

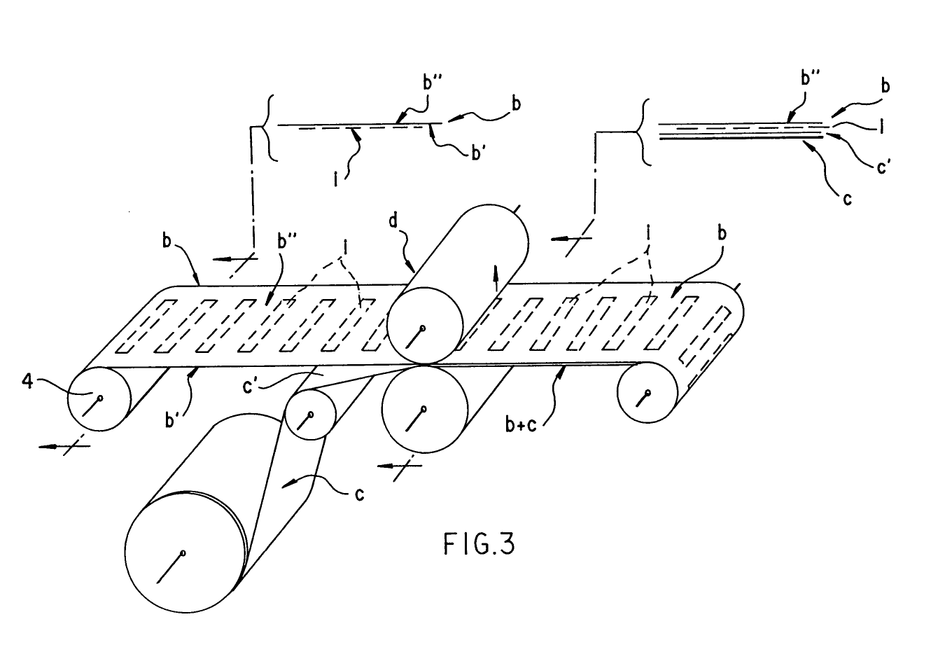

This establishes, as it is easy to understand and taking the risk of being redundant, a particular and basic characterization of the invented method, raised by the fact that we shall only apply to the selfadhesive compound c, when we proceed to the assembly of the labels laminating to the simple laminar material on same for its delivery in conditions of usage, operating as it is illustrated in the schemes of FIGS. 3 and 3′.

In consequence, the more expensive input is made up for the incorporation of the selfadhesive compound, which is only carried out in front of the specific demand and therefore it is possible to have available, at a very low cost, a wide range of printings i in coils 4, with a very high grade of perfection, ready to “assemble” without operative problems, any necessary volume of labels E, because with the essential part of same already “preprinted” according to this invention, it is possible to make changes, going from one type to another type of label (from one coil to another), when enter into the final stage of lamination on the selfadhesive compound, which is carried out according to the stated scheme of FIG. 3, in which the selfadhesive compound c together with the simple laminar material b with the printings i are supplied to the lamination train d, following which the resulting set goes through the device e of the die with half cut, and finally the grid 5 is detached, leaving the labels E clearly exposed and delimitated in the frontal c′ of the selfadhesive c, all this process as illustrated in FIG. 3′.

One feature of this method is the fact that in this final stage of “assembly” it is possible to discard the printed simple laminar material, when this is required by any circumstance, without implying practically any incidence in the cost of the final product, since it is discarded what values less.

It is worthwhile mentioning that this method makes possible, for example, to obtain a white label in basis of a preprinted one on a transparent film, by the simple fact of laminating this one on the white frontal of an adhesive compound.

On the other hand, having the same printed simple material, it is possible to satisfy any requirement of metallization or “stamping” imitations, by means of selfadhesive compounds having a metallized frontal.

To obtain transparent labels it is enough to use a selfadhesive compound c with a transparent frontal c′.

Within the scope of this invention it is studied the obtaining of a double face label to be applied on one side of the transparent wall of a container, a bottle, for example, in which case it is printed on both sides of a simple laminar material, paper or white film with equal performance, different graphic designs.

When assembling the compound, with simple laminar material printed on both sides, it is laminated on one transparent frontal of the selfadhesive compound, that later on, when extracting the liner carrier and when applying same on the container, allows to see the printing on reverse through its wall, remaining the obverse printing very reasonable.

Products different in their appearance due to their own features can also me manufactured (for example, a better finish in metallic ink and dark colors is obtained) than with traditional systems.

A particular feature of this method, concerning the results that are feasible to obtain with the application thereof, is what we call reduction of inventories. For a better understanding we point out the following:

Regarding the production of lots that are repeated over time with partial deliveries, this method is useful to reduce inventory costs related to space, and, as it was already stated, the cost of the simple material for printing is ¼ to 1/20 of selfadhesive compound, with which large lots may be printed for a period of 6 months or longer, on a low cost material per square meter (thus incurring only once in expenses adjustment and preparation for the printing) and the printed material is kept, for example, on a film occupying a smaller space, such as the 12-microns polyester or 25-microns polypropylene which also has a minimum cost.

On the other hand, all kind of changes in the graphic design that printing allows can be carried out without cost problems.

Then, and according to the demand requirements, lot/lots is/are laminated and cut in a die with half cut to register, to be delivered in the batch. This process (lamination and die cutting) is simpler and it is possible to carry out changes with lower costs than when the printing is performed directly on the selfadhesive according to the standard process.

Generally, there are several types of labels with the same die shape and with different varieties already printed, the lamination and die-cutting process is performed without no need to make any arrangements or adjustments, since one or other coil is used under same conditions, as it obviously does not matter the printing itself, thus obtaining a very sensitive costs reduction.

Due to the characteristics of this novel methodology, which essence is that the printing is not made on the selfadhesive, same, when not participating in the printing and being exclusively a support for the adhesive, allows to use lower cost materials, such as low cost blown polyethylene or low micronage polypropylene, polypropylene “cast” (flat monoriented extrusion), also of low cost, since a material with special features for printing that requires the conventional method is not needed, since the printing i, it is worth repeating it because it constitutes the main characterization factor of this invention, is carried out apart (off-line) and therefrom results a very sensitive low cost of the selfadhesive that now becomes possible to use with the object method, as there is no possibility that quality losses take place in the finished product, since the selfadhesive is only a support (“carrier”) of the adhesive which does not need to be printed.

Finally, it is necessary to add a synthesized general summary of the different characterization factors of the above referred invention:

a) Purpose of this Invention:

The purpose of this disclosure is to lower costs of production, reduce delivery times to the customer (for repetitive lots), allow to improve the quality of the product and reduce the inventory maintenance costs, for such repetitive lots, and also to reduce loss in case changes occur in the graphic design.

b) What is Known:

Usually, the “selfadhesive labels” are printed on the “finished selfadhesive compound”, the lamination and varnishing process is performed on-line, the die-cutting is made to half cut and the grid is skinned.

c) What is New:

The new process herein proposed comprises the printing, preferably, in the internal face of a plastic film such as polypropylene or polyester, basically a simple laminar material, that later is laminated on a selfadhesive compound and it is cut in a die (both on-line or off-line processes). It can also be carried out in white film or paper printing in one or both sides.

d) Advantages:

1. Cost:

A paper or clear film, with minimum cost compared to a finished selfadhesive is printed. The machine setting waste (color adjustment, register, etc.) is thus produced in a simple material, with very reduced value regarding a selfadhesive material.

2. Once printed (if it is laminated off-line) the wrong parts of the coil (rewinding) are removed and then the lamination process is carried out on a selfadhesive compound, this also lowers the cost because the well-printed material is only laminated. Take into account that the cost of the simple material (polypropylene, polyester) is about ¼ to 1/20 the cost of the selfadhesive compound.

3. Appearance and Quality:

When being printed on the internal face of the transparent film, the ink is directly seen and not through the lamination adhesive, leaving a better finish, without imperfections neither bubbles which are characteristic of the overlamination.

1. Being a white label, the transparent film is laminated in the reverse of white selfadhesive.

2. If it was necessary to make a metallized or “stamping” imitation, selfadhesive compounds with metallized frontal shall be used

3. For transparent labels, film and transparent selfadhesive compound shall be used.

4. In case that labels printed on both sides (transparent bottles) are required, paper or white film printing on both sides is performed, and then they are laminated on a selfadhesive with a transparent frontal which allows to see, through the adhesive, the printing in reverse and the other printed face remains as frontal. According to the way of processing, paper or polypropylene films or metallized or white polyester may be printed on both sides, then to laminate on an adhesive with transparent frontal, having as a result a label with an excellent printing also on the adhesive side, with a very high quality at a very reasonable cost.

5. Different products regarding the appearance can also be made due to the process characteristics (for example, a better finish is obtained in metallic inks and dark colors)

6. On-Line and Off-Line Laminate and Die-Cutting Process:

1. On-line printing, lamination and die-cutting process.

The process can also be made on-line obtaining more productivity (when the lots justify so), also getting more waste reduction, since the lamination process begins only when colors and register are adjusted so as not to produce waste in the selfadhesive compound.

2. Off-line lamination process. Inventories reduction:

When there are repetitive lots with partial deliveries, the process is useful to reduce the inventories as it has been already said, the cost of the film for printing is from 1 to 1/20 regarding the selfadhesive compound itself and thus, large lots can be printed for a period of 6 months or longer, on a simple material with very low cost per square meter (incurring only once in the setting expenses and preparation of the printing) and the printed material is kept on the film that occupies much smaller space (for example, 12-microns polyester or 25-microns polypropylene) regarding that required by the printed labels directly on the selfadhesive compound which also has a much lower cost.

Then, according to the orders from the customer, the lamination and die-cutting process is performed with half cut to register only for lots to be delivered in the required batch. This process (lamination and die-cutting) is simpler and it is possible to carry out changes at a cost lower than printing itself.

This is explained since, generally, there are several types with the same die form and having the different changes already printed, the lamination and die-cutting process is carried out without making arrangements or adjustments (they take place one after the other with the same die and adjustment, without caring about what is printed, thus obtaining a very sensitive costs reduction).

Selfadhesive Materials at Lower Price:

A particular characteristic of the invented method lies in the fact that, by not printing directly on the frontal of a conventional selfadhesive compound, the latter comprises a simple support for the adhesive on which the referred printed simple laminar material is to be glued and laminated carrier of the printing, and consequently it allows to use, in order to constitute this support, lower cost materials such as low cost blown polyethylene or low micronage polypropylene, polypropylene “cast” (flat monoriented extrusion), also of low cost, since a material of special characteristics for printing is not needed as the printing is carried out according to what was clearly above stated about a simple laminar material that has nothing to do with the referred film used as support, thus introducing a more than prominent low in the cost of the required selfadhesive compound, without implying any quality loss in the obtained label since, as it clearly comes out from the above description, the selfadhesive is simply a support “carrier”, that is to say, an adhesive frontal carrier on which no printing is done, since it is limited to act as a base over which the printed simple laminar material is laminated: paper, film, plastic, already registered and controlled in all the aspects required for the printing of a very good label.

Having thus described and determined the nature and scope of this invention and the way it must be taken to practice, it is claimed as of property and exclusive right:

1. A method for the manufacture of selfadhesive labels, of the type in which the labels are formed by an adhesive frontal involving a selfadhesive compound having a silicone base, “liner”, as a support, “carrier”, of the set, characterized in that it includes a first initial stage of printing of the label graphic design on a simple laminar material fully independent from the material of the selfadhesive compound, forming a coil from which it follows a complementary stage of inspection, developing the printed laminar material, so as to be able to thoroughly purify it and in all senses, according to the established parameters, discarding the wrong printed parts and making an assembly with the valid sections, in order to complete this stage with a final rewinding of this well printed simple laminar material, ready to be incorporated to the selfadhesive compound, and which coil is conducted to a warehouse for its direct use when the labels are required and, lastly, a second stage of direct incorporation of such printed simple material on the selfadhesive compound, proceeding to lamination so as to glue this printed laminar material on the compound frontal, under conditions which subsequently allow, its die-cutting to half cut and detachment from the grid comprised by the surplus of such simple laminar material carrier of the printing around the labels.

2. A method for the manufacture of selfadhesive labels, according to the foregoing claims, characterized in that the referred printing is carried out on a simple laminar material comprised by a paper, a plastic film or the like, having a very reduced thickness.

3. A method for the manufacture of selfadhesive labels, according to any of the foregoing claims, characterized in that the printing is made in the reverse or internal face of a transparent film.

4. A method for the manufacture of selfadhesive labels, according to claim 3, characterized in that the printing is made in the reverse internal face of a transparent film so that the ink film is seen directly from the obverse external face of the film.

5. A method for the manufacture of selfadhesive labels, according to any of the foregoing claims, characterized in that the simple laminar material is printed on both sides under white paper form, plastic or the like, so that a printed graphic design is obtained on both sides.

6. A method for the manufacture of selfadhesive labels according to any of the foregoing claims, characterized in that in the second stage, the simple laminar material, in which the label graphic design is printed, is laminated on its printed reverse on the selfadhesive compound frontal.

7. A method for the manufacture of selfadhesive labels, according to claim 5, characterized in that in the second stage, the simple material printed on both sides is laminated on a transparent frontal of the selfadhesive compound, so that when removing it, after the die-cutting process to half cut and detachment of the grid, a label is obtained with both printed graphic designs on both sides.
